(19) United States
(12) Patent Application Publication
(10) Pub. No.: US 2004/0050261 A1
(43) Pub. Date: Mar. 18, 2004

(54) Device and method for washing eggs

(76) Inventor: Paul K. Boutiette, Manchaug, MA (US)

Correspondence Address: Jenifer E. Haecki, Esq., Mirick, O'Connell, DeMallie & Lougee, LLP, 1700 West Park Drive, Westborough, MA, 01581, US

(21) Appl. No.: 10/242,744

(22) Filed: Sep. 12, 2002

(51) Int. Cl. A23B 4/08

(52) U.S. Cl. 99/536; 99/516

(57) ABSTRACT

Device and method for washing eggs, wherein the device generally comprises, one or more containers adapted to at least temporarily hold one or more liquids; one or more egg supporting members adapted to support the eggs and to allow the liquid to flow around the eggs when the egg supporting member is at least partially in the container; and one or more gas inlet members adapted to introduce one or more gases into the liquid.

### FIELD OF THE INVENTION

This invention relates to economical methods and devices that are adapted for washing a small to moderate number of eggs quickly and efficiently.

### BACKGROUND OF THE INVENTION

Mass production egg washers are a well-known means for large-scale egg producers to wash and process eggs. Such egg washers are typically capable of washing more than 100 cases of eggs per hour in which each case contains 360 eggs as described in U.S. Pat. No. 5,634,397. Most mass production egg washers are designed to increase the number of eggs that can be washed in a given period of time or to improve the degree of cleanliness achieved by the washing process. As far as it is known, all mass production egg washers move the eggs via a conveyor through a spraying system suspended over the conveyor such as the egg washers described in U.S. Pat. No. 4,125,914 to Warren; U.S. Pat. No. 4,569,444 to McEvoy et al.; and U.S. Pat. No. 5,758,378 to Kristensen. Brushes, either suspended from above or fixed to the conveying apparatus, serve to scrub the debris from the eggs as the eggs pass under the spraying system.

As noted by Hutchinson et al. in U.S. Pat. No. 5,634,397, most modern egg washers require four people to operate them and take up a considerable amount of floor space. These devices are very expensive and complex in design and typically beyond the means and capacity of small to moderate size egg producers. Many of the egg washers are even more complex and expensive, such as the washer disclosed by Hutchinson et al., because they are designed to carry out additional functions including passing the eggs through an egg candler to detect and discard rotten or contaminated eggs, and then through a breaking and separating apparatus and finally into a packaging system.

### SUMMARY OF THE INVENTION

It is therefore an object of the invention to provide a cost effective device and method for washing a small to moderate number of eggs.

It is another object of the invention to provide a device and method for washing eggs quickly and efficiently.

It is another object of the invention to provide a space saving device and method for washing eggs.

A preferred embodiment of the device of the invention for washing eggs, generally comprises: one or more containers adapted to at least temporarily hold one or more liquids; one or more egg supporting members adapted to support the eggs and to allow the liquid to flow around the eggs when the egg supporting member is at least partially in the container; and one or more gas inlet members adapted to introduce one or more gases into the liquid; wherein the egg supporting member preferably comprises a plurality of apertures, and wherein the liquid preferably is adapted to flow from the container through the apertures and around the eggs when the egg supporting member is at least partially in the container.

The gas inlet member may comprise one or more gas aperture members having one or more apertures through which the gas is adapted to pass from the aperture member into the liquid; and one or more gas valves, wherein the gas inlet member may further comprise one or more gas inlet tubes connected to the gas valve and the aperture member; and may comprise one or more gas chucks connected to one or more of the gas inlet members; and one or more gas compressors connected to one or more of the gas chucks.

The container may also further comprise one or more base support members adapted to support the egg supporting member when the egg supporting member is at least partially in the container; wherein at least a portion of one or more of the base support member may be at least partially between one or more of the gas aperture members and the egg supporting member when the egg supporting member is at least partially in the container; wherein the container may have a bottom and wherein one or more of the gas aperture members is preferably proximate the bottom of the container to allow the gas to rise upwards through the liquid.

The device may still further comprise one or more egg stabilizing members adapted to reduce unnecessary movement of the eggs in the egg supporting member; wherein one or more of the egg stabilizing members preferably comprises one or more weighted members.

The container preferably holds between about 3 to 30 gallons of liquid. Various embodiments may be specifically designed to hold virtually any amount of liquid including, but not limited to, about three gallons of liquid, five gallons of liquid, or 30 gallons or less of liquid, or if smaller or larger batches are desired then less than 3 gallons or greater than 30 gallons, respectively, as needed. The gas compressor is preferably adapted to provide gas flow at about two cubic feet per minute, however, the gas flow rate may be adjusted based on the size of the container and amount of liquid, or as otherwise needed or desired for effective cleaning.

Another preferred embodiment of the device of the invention for washing egg, generally comprises: one or more containers adapted to at least temporarily hold between about 3 to 30 gallons of one or more liquids; one or more egg supporting members adapted to support the eggs and to allow the liquid to flow around the eggs when the egg supporting member is at least partially in the container; one or more gas inlet members adapted to introduce one or more gases into the liquid at a rate and pressure sufficient to create a turbulent, bubbling action in the liquid; and one or more gas chucks connected to one or more of the gas inlet members; and one or more gas compressors connected to one or more of the gas chucks. The liquid preferably comprises one or more additives selected from a group consisting of cleansers, biocides, alkaline components, bleaching agents, and defoamers. In instances wherein the container has a defined bottom and wherein one or more of the gas inlet members is proximate the bottom of the container to allow the gas to rise upwards through the liquid.

A preferred method of the invention for washing eggs, generally comprises the steps of: loading one or more egg supporting members with the eggs; at least partially placing the egg supporting member in one or more containers adapted to at least temporarily hold one or more liquids; introducing one or more gases into the liquid via one or more gas inlet members at least in part to create turbulence in the liquid; wherein one or more of the egg supporting members is adapted to allow the liquid to flow around the eggs. At least one of the egg supporting members may comprise a basket.

The method preferably comprises the step of filling one or more of the containers with 30 gallons or less water; and may specifically comprise filling one or more of the containers with 5 gallons or less water.

One or more of the gases may be introduced into the liquid through one or more of the gas inlet members at a rate of about two cubic feet per minute and a pressure of about 30 psi.

The method may still further comprise the step of adding one or more additives to the liquid selected from a group consisting of cleansers, biocides, alkaline components, bleaching agents, and defoamers; wherein the additives preferably comprise an alkaline, chlorinated, foam-controlling powder that is adapted to clean the eggs, kill bacteria, destain the eggs and limit foam accumulation.

Another preferred method of the invention for washing eggs, generally comprises the steps of: loading one or more egg supporting members with the eggs; filling one or more containers, adapted to at least temporarily hold liquids, with 3 to 5 gallons of water; adding one or more additives to the water selected from a group consisting of cleansers, biocides, alkaline components, bleaching agents, and defoamers; at least partially placing the egg supporting member in one or more of the containers; introducing one or more gases into the liquid in the container via one or more gas inlet members at least in part to create turbulence in the liquid, wherein one or more of the egg supporting members is adapted to allow the liquid to flow around the eggs, and wherein one or more of the gas inlet members introduce gas into the liquid below the egg supporting member. One or more of the gases are preferably introduced into the liquid at a rate of about two cubic feet per minute and a pressure of about 30 psi, and the additives preferably comprise an alkaline, chlorinated, foam-controlling agent that is adapted to clean the eggs, kill bacteria, destain the eggs and limit foam accumulation.

### BRIEF DESCRIPTION OF THE DRAWINGS

Other objects, features and advantages will occur to those skilled in the art from the following description of the preferred embodiments and the accompanying drawings in which:

FIG. 1 is a side view of the preferred embodiment of the device of the invention for washing eggs; and

FIG. 2 is a perspective view of the base support member of the device of the invention.

### DETAILED DESCRIPTION OF THE PREFERRED EMBODIMENTS

The invention features novel egg washers and methods that enable small-scale farmers to wash a moderate number of eggs quickly and efficiently without having to wash the eggs either by hand or by large, expensive, mass production machines used by large scale egg producers. The preferred embodiment of the egg-washing device of the invention uses a hydro-pneumatic (water/air) cleaning action.

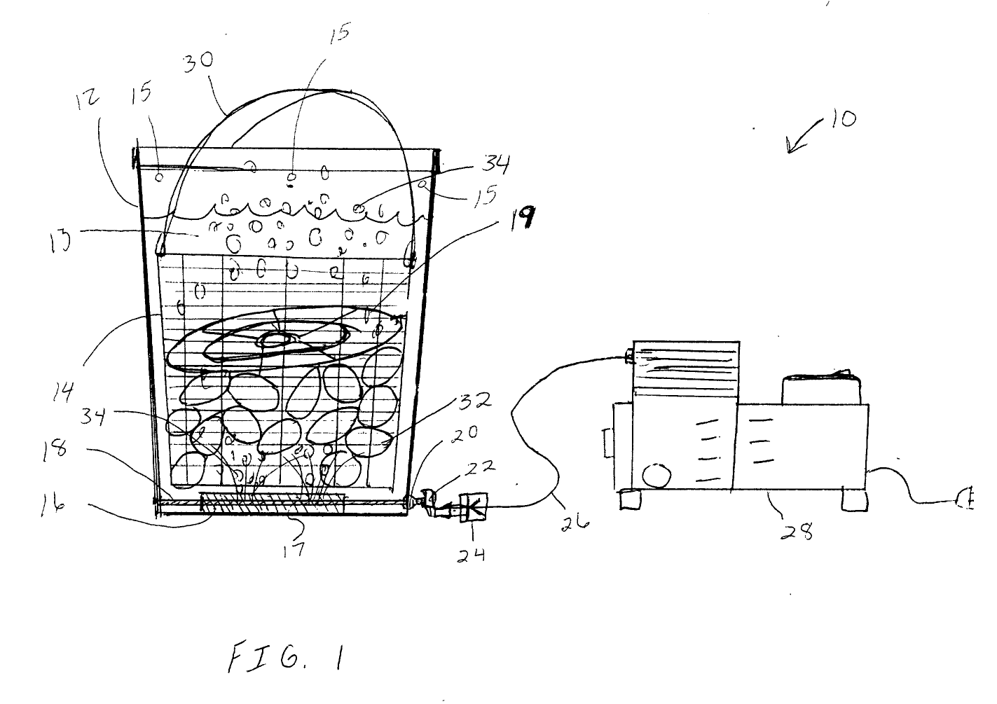

The egg-washing device of the invention is shown and generally referred to in FIG. 1 as device 10. Device 10 for washing eggs, generally features, one or more containers 12 adapted to at least temporarily hold one or more liquids 13; one or more egg supporting members 14 adapted to support the eggs and to allow the liquid to flow around the eggs when the egg supporting member is at least partially in the container; and one or more gas inlet members 17 that is adapted to introduce one or more gases 34 into the liquid.

The egg supporting member 14 is preferably a basket with a handle 30 having plurality of apertures through which liquid 13 is adapted to flow from the container and around eggs 32 when the egg supporting member 14 is at least partially in container 12. The size of the basket will depend on the size of container 12 or on the number of eggs to be washed. For example, in one of the preferred embodiments container 12 has a diameter about 12 inches and a liquid volume of about 5 gallons, and the basket is 10 inches in diameter at the top and tapers slightly towards the bottom. A 14 inch diameter basket typically holds about 15 dozen eggs, a 10 inch diameter basket holds about 8 dozen eggs, and an 8 inch diameter basket holds about 4 dozen eggs. The basket should be made of a sturdy construction. The basket preferably is made from a heavy gauge, coated wire to cushion the eggs and prevent corrosion.

Gas inlet member 17 generally comprises one or more gas aperture members 18, preferably a tube, having one or more apertures through which gas 34 is adapted to pass from aperture member 18 into liquid 13, and one or more gas valves 20. The gas inlet member preferably also includes one or more gas inlet tubes 26 connected to gas valve 20 and thus aperture member 18. The preferred tube of aperture member 18 is preferably a 5/16″ stainless steel tubing air pipe. Gas valve 20 may be any suitable gas valve although an automotive tire valve works well with the preferred embodiment. Gas inlet member 17 also preferably includes a gas chuck 22, such as a tire air chuck, and a gas chuck value 24 to adequately connect gas inlet tube 26 to gas valve 20 and to control the flow of air from compressor 28 to container 12. In the preferred embodiment, compressor 28 is preferably an air compressor that is capable of delivering gas at 2 cubic feet per minute at a pressure of 30 psi.

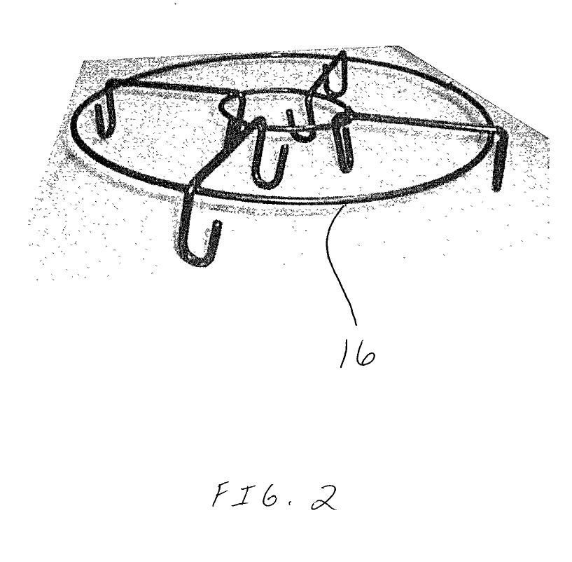

Container 12 preferably includes one or more base support members 16 that are adapted to support egg-supporting member 14 when egg-supporting member 14 is at least partially placed in container 12. In the preferred embodiment, base support member 16 preferably comprises a circular raised grate manufactured from plastic coated wire as shown in FIG. 2, but may comprise any other suitable materials such as ¾″ square aluminum tubing. Although the air inlet members may be positioned at various locations on device 10, at least one air inlet member is preferably located at or near the bottom of container 12 so that the pressurized air flows upward through the eggs. As such, at least a portion of one or more of the base support members is preferably positioned between one or more of the gas aperture members and one or more of the egg supporting members.

Device 10 may also be used with one or more egg stabilizing members 19 that are adapted to reduce unnecessary movement of the eggs when the egg supporting member 14 is at least partially in container 12 and particularly when pressurized air is being forced into the liquid to cause turbulence in the liquid to facilitate the cleaning action. The egg stabilizing members may comprise one or more weighted members such as a weighted disc having a diameter that is less than the diameter of egg supporting member 14. For example, for a 10″ diameter basket, the weight disc is preferably between 7½ and 8½″ in diameter.

A preferred method of the invention generally comprises the steps of: loading one or more egg supporting members with the eggs; at least partially placing egg supporting member 14 in one or more containers 12 that are adapted to at least temporarily hold one or more liquids 13; and introducing one or more gases 34 into liquid 13 via one or more gas inlet members 17 at least in part to create turbulence in liquid 13; wherein one or more of egg supporting members 14 is adapted to allow liquid 13 to flow around eggs 32.

More specifically, to begin washing eggs using the preferred method of the invention, all of the components with which the eggs 34 or liquid 13 come in contact should be thoroughly washed with hot water prior to use to remove any debris. If container 12 is a 5-gallon container it should then be filled with about 3 gallons of 90° F. water and a suitable amount of a cleansing material is added to the water. The cleansing material is preferably a powder for soaking and mechanically washing the eggs. The powder may contain any number of suitable additives and preferably contains one or more cleansers, biocides, alkaline components, bleaching agents, and defoamers. The preferred method uses an alkaline, chlorinated, foam-controlling powder that is adapted to clean, kill bacteria, destain the eggshells, and limit foam accumulation in device 10. After the cleaning process is complete, the eggs should be rinsed thoroughly with clean 90° F. water.

After the powder is dissolved, a 10-inch basket, in which a plurality of eggs are properly spaced to have the top layer of the eggs as flat as possible, is inserted into container 12. Weighted disc 19 is gently laid on top of the eggs. Disc 19 should have a diameter that closely fits the diameter of basket 13. If only one or two layers of eggs are being cleaned, then a smaller disc should be used. If basket 13 is more than half full, then a larger disc should be used. Add water as necessary to bring the height of the liquid to 1 to 2 inches above the top of the eggs.

Gas chuck 22 is then attached to gas valve 20 and then compressor 28 is turned on. Gas check valve 24 is preferably a one-way check valve to prevent the egg-cleaning solution from backing up into compressor 28 when the compressor is turned off. Compressor 28 preferably has a regulator for selectively setting the airflow of the compressor to the desired gas pressure. The airflow should be set to create a turbulent, but not violent, bubbling action in the egg washer. Too much airflow will cause the eggs to bounce and crack. The preferred airflow is about 2 cubic feet of air per minute.

Container 12 should be covered loosely with a cover (not shown) to avoid splashing water. To prevent an unsafe build up of air pressure inside container 12 in the event that a cover is inadvertently affixed tightly to container 12, a plurality of safety vent holes 15 are pre-punched near the top lip of container 12 allowing air to escape.

After approximately 15 minutes or less, more if needed or desired, the eggs should appear clean. The compressor is then turned off first and the inlet tube 26 disengaged from the air valve. The cover, weighted disc 19, and the egg supporting member or basket 14 are then removed and the basket allowed to drain. The wash water in container 12 should be discarded.

Container 12 should again be filled with about 3 gallons of 90° F. rinse water with no additives or chemicals. Basket 14 is placed back in container 12 followed by weighted disc 19 and the cover loosely placed over the container. Fix the air chuck 22 attached to inlet tube 26 to the valve stem of gas valve 20 and start compressor 28. Run the compressor for at least 3 minutes, or as needed, to allow the eggs to be rinsed thoroughly with turbulent water. After about 3 minutes, the compressor should again be shutdown and the inlet tube disengaged. Remove basket 14 after removing the cover and weighted disc 19 and run warm water over the eggs while still in basket 14 to complete a final rinse. The eggs may be removed by hand and inspected for any remaining debris. Any remaining debris may be washed off with an egg brush (not shown) under running warm water.

The eggs may be air dried in the basket or on a suitable absorbent surface and then immediately stored under refrigeration. Container 12 and basket 14 should be rinsed and cleaned with hot water to remove any debris, including debris that may have settled at the bottom, and then dried.

Although specific features of the invention are shown in the drawing, this is for convenience only as some feature may be combined with any or all of the other features in accordance with the invention. The size, shape, and material of any of the components of the device are not necessarily limited to any one particular size, shape, or material, but will depend on a given application setting and the desired number of eggs to be washed. Furthermore, both the device and methods of the invention may be adapted for manual or automated use.

Other embodiments will occur to those skilled in the art and are within the following claims:

What is claimed is:

1. Device for washing eggs, comprising,
one or more containers adapted to at least temporarily hold one or more liquids;
one or more egg supporting members adapted to support said eggs and to allow said liquid to flow around said eggs when said egg supporting member is at least partially in said container; and
one or more gas inlet members adapted to introduce one or more gases into said liquid.

2. The device of claim 1, wherein said egg supporting member comprises a plurality of apertures, and wherein said liquid is adapted to flow from said container through said apertures and around said eggs when said egg supporting member is at least partially in said container.

3. The device of claim 1, wherein said gas inlet member comprises,
one or more gas aperture members having one or more gas apertures through which said gas is adapted to pass from said aperture member into said liquid; and
one or more gas valves.

4. The device of claim 3, wherein said gas inlet member further comprises one or more gas inlet tubes connected to said gas valve and said aperture member.

5. The device of claim 1, wherein said container further comprises one or more base support members adapted to support said egg supporting member when said egg supporting member is at least partially in said container.

6. The device of claim 5, wherein at least a portion of one or more of said base support members is at least partially between one or more of said gas aperture members and said egg supporting member when said egg supporting member is at least partially in said container.

7. The device of claim 6, wherein said container has a bottom and wherein one or more of said gas aperture members is proximate said bottom of said container to allow said gas to rise upwards through said liquid.

8. The device of claim 1, further comprising one or more egg stabilizing members adapted to reduce movement of said eggs in said egg supporting member.

9. The device of claim 8, wherein one or more of said egg stabilizing members comprises one or more weighted members.

10. The device of claim 1, further comprising one or more gas chucks connected to one or more of said gas inlet members; and one or more gas compressors connected to one or more of said gas chucks.

11. The device of claim 10, wherein said container is adapted to hold at least three gallons of liquid and wherein said gas compressor is adapted to provide gas flow at about two cubic feet per minute.

12. The device of claim 1, wherein said container is adapted to hold five gallons or less liquid.

13. The device of claim 1, wherein said container is adapted to hold at least 30 gallons of liquid.

14. The device of claim 1, wherein said container is adapted to hold 30 gallons or less of liquid.

15. The device of claim 1, wherein at least one of said egg-supporting members comprises a basket.

16. The device of claim 1, wherein said liquid comprises one or more additives selected from a group consisting of cleansers, biocides, alkaline components, bleaching agents, and defoamers.

17. Device for washing eggs, comprising,
one or more containers adapted to at least temporarily hold between about 3 to 30 gallons of one or more liquids;
one or more egg supporting members adapted to support said eggs and to allow said liquid to flow around said eggs when said egg supporting member is at least partially in said container;
one or more gas inlet members adapted to introduce one or more gases into said liquid at a rate and pressure sufficient to create a turbulent, bubbling action in said liquid; and
one or more gas chucks connected to one or more of said gas inlet members; and one or more gas compressors connected to one or more of said gas chucks.

18. The device of claim 17, wherein said liquid comprises one or more additives selected from a group consisting of cleansers, biocides, alkaline components, bleaching agents, and defoamers.

19. The device of claim 17, wherein said container has a bottom and wherein one or more of said gas inlet members is proximate said bottom of said container to allow said gas to rise upwards through said liquid.

20. A method for washing eggs, comprising the steps of:
loading one or more egg supporting members with said eggs
at least partially placing said egg supporting member in one or more containers adapted to at least temporarily hold one or more liquids;
introducing one or more gases into said liquid via one or more gas inlet members at least in part to create turbulence in said liquid; wherein one or more of said egg supporting members is adapted to allow said liquid to flow around said eggs.

21. The method of claim 20, wherein at least one of said egg supporting members comprises a basket.

22. The method of claim 20, further comprising the step of filling one or more of said containers with 30 gallons or less water.

23. The method of claim 22, wherein said step of filling comprises filling one or more of said containers with 5 gallons or less water.

24. The method of claim 20, wherein one or more of said gases are introduced into said liquid through one or more of said gas inlet members at a rate of about two cubic feet per minute and a pressure of about 30 psi.

25. The method of claim 20, further comprising the step of adding one or more additives to said liquid selected from a group consisting of cleansers, biocides, alkaline components, bleaching agents, and defoamers.

26. The method of claim 25, wherein said additives comprise an alkaline, chlorinated, foam-controlling powder that is adapted to clean the eggs, kill bacteria, destain the eggs and limit foam accumulation.

27. A method for washing eggs, comprising the steps of:
loading one or more egg supporting members with said eggs;
filling one or more containers, adapted to at least temporarily hold liquids, with 3 to 5 gallons of water;
adding one or more additives to said water selected from a group consisting of cleansers, biocides, alkaline components, bleaching agents, and defoamers;
at least partially placing said egg supporting member in one or more of said containers;
introducing one or more gases into said liquid in said container via one or more gas inlet members at least in part to create turbulence in said liquid, wherein one or more of said egg supporting members is adapted to allow said liquid to flow around said eggs, and wherein one or more of said gas inlet members introduce gas into said liquid below said egg supporting member.

28. The method of claim 27, wherein at least one of said egg-supporting members comprises a basket.

29. The method of claim 27, wherein one or more of said gases are introduced into said liquid at a rate of about two cubic feet per minute and a pressure of about 30 psi.

30. The method of claim 27, wherein said additives comprise an alkaline, chlorinated, foam-controlling agent that is adapted to clean the eggs, kill bacteria, destain the eggs and limit foam accumulation.
